(19) United States
(12) Patent Application Publication
(10) Pub. No.: US 2016/0227474 A1
(43) Pub. Date: Aug. 4, 2016

(54) Multi-device network setup

(71) Applicant: Vizio Inc, Irvine, CA (US)

(72) Inventor: Matthew Blake McRae, Irvine, CA (US)

(21) Appl. No.: 14/612,355

(22) Filed: Feb. 3, 2015

(51) Int. Cl. H04W 48/16; H04L 12/24; G06F 3/0484; H04W 76/02

(52) U.S. Cl. CPC H04W 48/16; H04W 76/02; H04L 41/22; G06F 3/04842

(57) ABSTRACT

A simplified way of connecting electronic devices with limited user input capabilities to wireless network routers. A smart device with a user interface and input capabilities is connected to a Wifi router and remembers the Wifi variables used for the connection. It is then paired with the electronic device and transfers the Wifi connection variables to the electronic device. The smart device with the first software program has a user interface that facilitates the user initially connecting with a local Wifi router. The connection variables used during the connection process are saved by the smart device. The user may then connect the smart device to the electronic device via a paired communications link and the connection variables for the router are passed over the link. The electronic device executing the second software module connects to the router using the connection variables it received from the smart device.

### BACKGROUND

Devices such as televisions may be shipped with a remote control device which may be a classic hand held remote control device or a mobile smart remote or multiple remote control devices some of which may have display screens and physical or virtual keyboards.

Many televisions capable of being connected to the internet have user interfaces which among other features allow the user to setup wireless options for WiFi. Locating WiFi routers that broadcast their SSID in the clear can be confusing to the average user, especially when the television is located in an environment such as a residential area where multiple residences contain at least one Wifi Router or multiple residences may contain routers with the same SSID name.

This is even more difficult for Wifi Routers that do not broadcast their ID. This scenario requires entering long strings of SSID names or MAC addresses or filling out a form that identifies a WiFi Router. This is even more difficult when using a television based user interface. Other devices such as DVD players and other devices lacking display screens or very limited display screens but with Wifi capability are equally challenging to connect to a wireless router.

### SUMMARY

The inventor recognized the need for some way to simplify the process of setting up a wireless link between a router and a television.

Another need recognized is for a connection between multiple televisions and a single router.

A simplified way of connecting electronic devices with limited user input capabilities to wireless network routers is disclosed such as a DVD player, Television, microwave oven, etc. A smart device with a user interface and input capabilities is first connected to a Wifi router and has programming to remember the Wifi variables used for the connection. That smart device is then paired with the electronic device and transfers the Wifi connection variables to the electronic device.

The smart device has a user interface, and a first software program. The smart device, such as a tablet computer, laptop, or smart phone with the first software program has a user interface that facilitates the user initially connecting with a local Wifi router. The connection variables used during the connection process are saved by the smart device. The user may then connect the smart device to the electronic device via a paired communications link and the connection variables for the router are passed over the link. The electronic device executes a second software module to connect to the router using the connection variables it received from the smart device.

### BRIEF DESCRIPTION OF THE DRAWINGS

in the drawings:

FIG. 1 is a high level depiction of one embodiment of the invention showing a television, smart remote, and a wireless router.

FIG. 2 is a depiction of the logic flow which shows the elements in a connected television and the elements in a smart remote control device used to connect to a Wifi access point then transfer the connection variables to the television for connection to the same Wifi access point.

FIG. 3 is a high level depiction of one embodiment of the invention where two televisions are paired with a single smart remote and the two televisions and the smart remote all communicating with the single Wifi access point.

FIG. 4 is a depiction of the logic flow for a callable function, called from FIG. 2, that performs the actual connection logic for connecting the smart remote control device to a Wifi connection point.

### DETAILED DESCRIPTION

Embodiments describe a smart remote which may be paired with a television at the factory or may pair automatically when both devices are initially powered on and placed in close proximately to each other. The smart remote may be based on a tablet computer, smart cell phone, PDA, or a purpose built smart remote.

For the present application, it will be assumed that the smart remote will be a hand held tablet computer. The smart remote controls at least one function of the remote device (Television), for example the on-off function, for a television and the channel changing, and for other devices such as ovens and garage doors, controls the their appropriate operations. The tablet user interface being executed on a touch sensitive device allows for a richer experience. In this environment, the user can be presented with a list of discovered Wifi Routers and their names. This functionality allows the user to more easily identify the Wifi Router or to enter the name of a router that does not broadcast its SSID and to enter a password and/or the MAC address of the client device.

Once the Wifi Router is identified, selected, and a password entered, the tablet remote control device can setup the Wifi wireless link between its paired television and the Wifi by passing the credentials for access across a secure link or to the television or on an out of band link. In the event a Wifi wireless enabled handheld remote control device is included with the television, the tablet can pass the Wifi credentials to that device as well.

An embodiment describes operation using Bluetooth, however it should be understood that other formats can be used.

Bluetooth devices may pair with multiple other devices and as such, provisions are made for a tablet remote control device being able to populate Wifi credentials across multiple other devices (televisions, DVD players, Tuners, Home Theater Systems, Game Controllers, Microwave Ovens, etc.) that the tablet is paired with.

In a preferred embodiment, a smart device, such as a desk top computer, tablet computer, smart phone, smart mobile remote, or a PDA has a user interface that has advanced functions (e.g., keyboard and/or touchscreen). This smart device is paired with an electronic device having limited user interface capabilities (such as a television, DVR, microwave ovens, refrigerators, heaters, and other consumer electronic devices). The smart device, e.g. a tablet, will then be connected with a local wireless router. Once the connection process with the wireless router is completed, the tablet transmits the connection variables that will allow the limited capability device to communicate with the wireless router over the paired link.

More generally, the smart device can be any device that has either a full keyboard or a soft keyboard displayed on a touchscreen, and the electronic device having limited user interface capabilities required entry of the information either on a remote control that enters data using arrows to select between options, or using an on-device user interface that again requires the use of navigation arrows.

In a related embodiment, the smart device may be paired with multiple electronic devices either before or after the smart device has been connected to a wireless router. In this embodiment, the smart device can be directed by the user to transmit the connection variables to more than one electronic device over any of the paired links and the connection variables that will allow the electronic device to be linked to the wireless router will be transmitted to the electronic device(s).

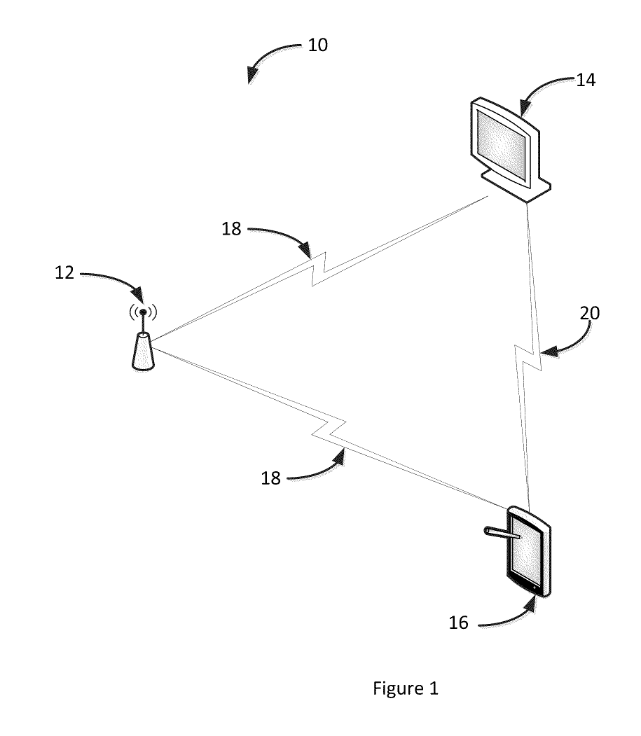

Now referencing FIG. 1 where 10 depicts a basic embodiment of the invention. In this depiction, Wifi AP 12 can communicate with both television 14 and smart remote 16. In this depiction, communications links 18 use the Wifi protocol for communicating. Communications link 20 is a secure communications like between smart remote 16 and television 14. Communications link 20 may be a Bluetooth, MyriaNed, Near Field Communications (NFC), ZigBee, RuBee, Bidirectional IR, Li-Wi, or any other RF, IR, or visible light bidirectional protocol that is secure.

In this high level depiction, television 14 and smart remote 16 will, when they are first powered on, enter a pairing mode. The pairing mode will be initiated by the user and will allow the two devices to recognize each other and to enable a secure communications link between them. For clarity, secure connection 20 between television 14 and smart remote 16 will be assumed to be Bluetooth. In this scenario, smart remote 16 will be the Master and television 14 will be the Slave. The Master device (smart remote 16) will initiate the connection with the Slave (television 14).

After the pairing mode has completed, smart remote 16 searches for a Wifi AP such as Wifi AP 12. Smart remote 16 then operates, after inventorying the Wifi APs that it can “see”, to display a list of Wifi APs to the user. The user selects one of the Wifi APs and smart remote 16 asks for the password for the selected Wifi AP. The user enters the password for the selected Wifi access point and smart remote 16 attempts to connect to the selected Wifi AP. If the connection attempt times out before the connection is made or the password is rejected by Wifi AP 12, smart remote 16 assumes that the password entered by the user was incorrect and will notify the user that the password was not recognized by the selected Wifi AP. The process then returns to displaying a list of Wifi APs to the user and the user will have the opportunity to reselect a Wifi AP and to enter a password. If the connection attempt is successful, smart remote 16 will send a message to television 14 to launch an application that will attempt to connect to the same Wifi AP that smart remote 16 is currently connected to.

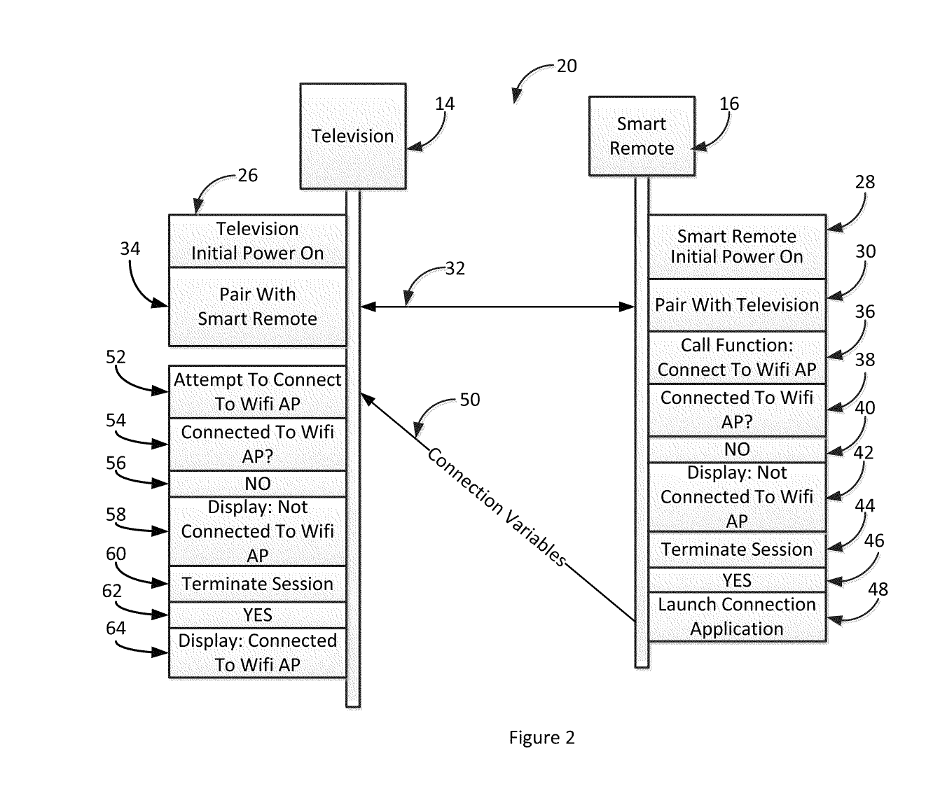

When smart remote 16 sends the message to television 14 to launch the connection application, the connection variables or credentials necessary for the connection to take place are sent as signal 50 (FIG. 2) connection variables. Television 14 operates, in response to the launch application message and associated connection variables/credentials, to launch the connection application processing block 52 (FIG. 2) and to attempt to connect to Wifi AP which will receive the associated connection variables/credentials. The television operates, using the connection variables such as the Wifi access point 12 IP address, to attempt to connect to Wifi access point 12. If Wifi access point 12 is secured with encryption, the protocol operating the Wifi access point requests a password from television 14. At this point, television 14 sends the password it received as part of the connection variables received from smart remote 16. If Wifi AP 12 accepts the password from television 14, the connection is completed. If the password is rejected or the request times out, television 14 displays an error dialog on the display screen informing the user of the failure.

Now referencing FIG. 2 where 20 depicts television 14 and smart remote 16. In this depiction, both television 14 and smart remote 16 are initially powered on. Television 14 is initially powered on at processing block 26 television initial power on. After being powered on, control falls through to processing block 34 pair with smart remote 16. This processing block places the television into a “pairing” mode which in this embodiment designates television 14 as a Bluetooth Slave. This mode will essentially be broadcasting its ID over a known frequency.

Smart remote 16 is initially powered on at processing block 28 smart remote initial power on. After being powered on, control falls through to processing block 30 pair with television. In this embodiment, smart remote 16 is designated as a Bluetooth Master. Processing block 30 pair with television and processing block 34 pair with smart remote complete the pairing process for which ever secure protocol is being used for communications link 20 which in this embodiment is Bluetooth.

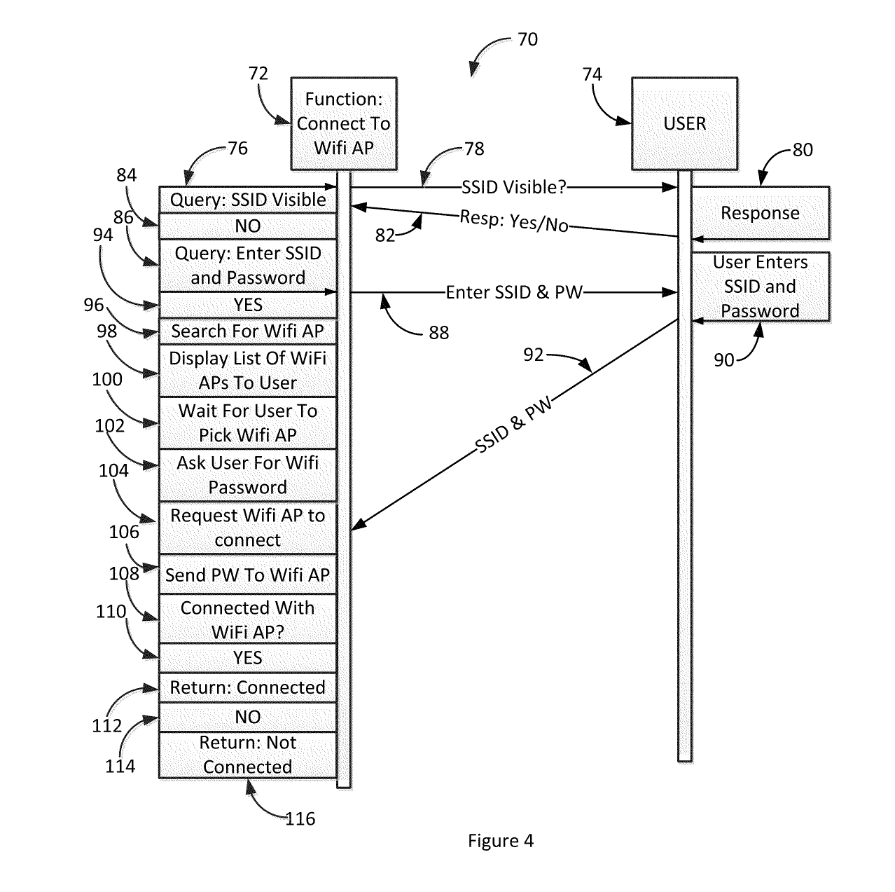

After communications link 20 has been established between television 14 and smart remote 16, control falls through to call function processing block 36 call function: connect to Wifi AP. This processing block calls the function depicted in FIG. 4, function processing block 72 function: connect to Wifi AP.

Processing block 36 waits for the called function to return with a return status. After the function has returned to processing block 36, control falls through to decision block 38 connected to Wifi AP? If the return status from the function was “not connected”, control will transfer to result processing block 40 NO after which control will fall through to display processing block 42 display: not connected to Wifi AP which informs the user that the connection process failed. Control then falls through to terminate processing block 44 terminate session.

If the return status from the function was “connected”, control will transfer to result processing block 46 YES after which control will fall through to display processing block 48 launch connection application. This processing bock sends a “launch application” (connection variables 50) request to television 14 over communications link 20. The launch application request to television 14 will be sent via signal 50 connection variables to television 14 processing block 52 attempt to connect to Wifi AP. This processing block will receive connection variables 50 including the SSID of the Wifi AP and the password, if any, used by remote control device 16 to gain access to the targeted Wifi AP. This process block will contact Wifi AP 12 using the provided SSID and if prompted by Wifi AP 12 for the password it will send the password after which control will fall through to decision processing block 54 connected to Wifi AP? The decision processing block waits for a predetermined period of time for an acknowledgement from Wifi AP 12 that television 14 is connected or that the password was rejected or the connection request timed out. If the password was rejected or the connection request timed out, control is transferred to results processing block 56 NO after which control will fall through to display processing block 58 display: not connected to Wifi AP after which control will fall through to processing block 60 terminate session. If decision processing block 54 received an acknowledgement of “connected” control is transferred to results processing block 62 YES after which control will fall through to display processing block display: connected to Wifi AP.

At this point, both television 14 and smart remote 16 are both connected to Wifi AP 12 and to each other via secure communications link 20.

Now referencing FIG. 4 where 70 depicts function: connect to Wifi AP 72 and User 74. In this depiction, function: connect to Wifi AP 72 starts executing at query processing block 76 query: SSID visible. This processing block displays a query to user 74 then sends signal 78 SSID Visible? User 74 makes a determination if the SSID of his target Wifi AP 12 is visible or hidden. If the SSID of Wifi AP 12 is hidden, user response 80 will send signal 82 resp: NO to query processing block 76. If the response was NO, control transfers to results processing block 84 NO after control will fall through to query processing block 86 query: enter SSID and password. This processing block sends signal 88 enter SSID & PW to user processing block 90 user enters SSID and password. At this point, the user enters the SSID and password for Wifi AP 12 which is sent to processing block 104.

If the user response at user response block 80 was yes, then query processing block 76 would have transferred control to results processing block 94 YES after which control will fall through to processing block 96 search for Wifi AP. This processing block listens on all of the Wifi channels for Wifi access points (AP) that broadcast their Service Set Identifier (SSID) which is a 32-character string (the characters can be anything a computer can type, such as a letter, number, symbol, punctuation mark, and even a blank space). A wireless network can be either hidden or visible. If the SSID is broadcast (visible), then anyone can find that network access point and connect if they have the password.

Once processing block search for Wifi AP 96 has collected the SSIDs of all broadcasting Wifi Aps, control falls through to processing block 98 display list of Wifi APs to user. This processing block displays an ordered list of Wifi APs along with their SSIDs. The user is prompted to select one of the Wifi APs after which control will fall through to processing block 100 wait for user to pick Wifi AP.

This processing block waits until the user selects one of the Wifi APs listed in the displayed list; after which control will fall through to processing block 102 ask user for Wifi password. At this point, control will fall through to processing block 104 request Wifi AP to connect. This processing block will contact targeted Wifi AP 12 using the provided SSID for targeted Wifi AP 12. Targeted Wifi AP 12 will, if it is secured with encryption, request a password. Control will at this point fall through to processing block 106 send PW to Wifi AP.

This processing block sends the user entered password to Wifi access point 12 after which control will fall through to decision processing block 108 connected with Wifi AP?.

This decision block waits for a predetermined period of time for Wifi AP 12 to respond to the connection request. If Wifi AP 12 responds within the predetermined period of time verifying the connection, control transfers to results processing block 110 YES after which control falls through to return processing block 112 return: connected. This processing block returns to the caller with a return status of “connected”.

Similar operations can be carried out, for example, to connect the tablet to the access point using an automatic, e.g. button connection such as WPS, and then to transfer that WPS-obtained connection to the television. In the case of WPS, the password is received wirelessly, where the term password refers to any kind of connection variable received as part of the automatic connection. If the automatic connection is MAC ID's sensitive, that is the automatic connection made from the tablet would not work on the electronic device, then the tablet can be used to initiate the automatic connection with the television so that the automatic connection is creating with and using the MAC ID of the television.

If decision processing block 108 determines that the response from connected request was rejected or timed out, control is transferred to results processing block 114 NO after which control falls through to return processing block 116 return: not connected. This processing block will return to the caller with a return status of “not connected”.

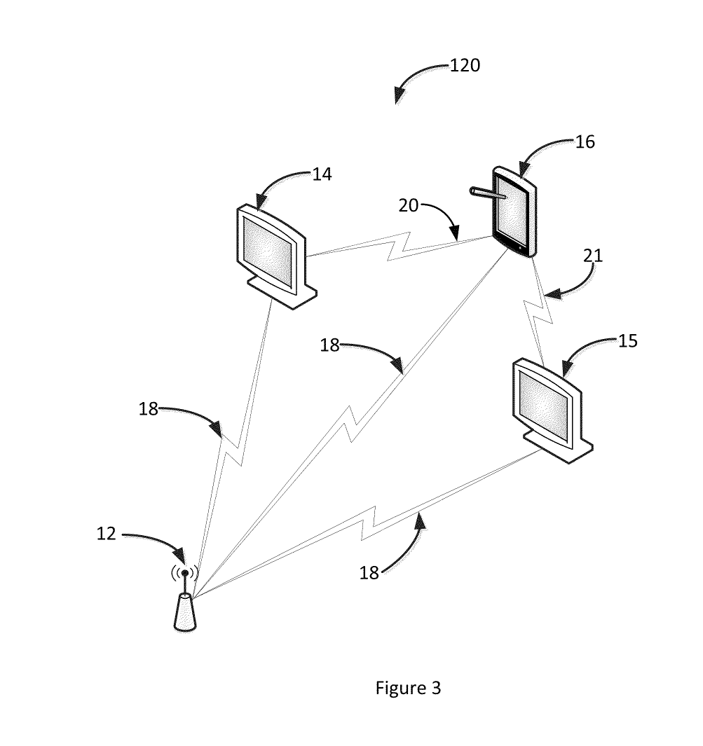

Now referencing FIG. 3 where 120 depicts an embodiment of the present invention where two televisions 20 and 21 are connected to Wifi AP 12 via communications link 18 as is smart remote 16. In this embodiment, smart remote 16 is designated as a Bluetooth Master device and in paired with televisions 14 and 15 via secured communications links 20 and 21. In this depiction, televisions 14 and 15 would typically be in different areas of a household or a business. Bluetooth communications links may typically be able to communicate through wall obstructions depending on the transmit power of the device and the composition of materials contained in walls. There are two possible scenarios with this embodiment.

First scenario, smart remote 16 communicates with each television regardless of where televisions 14 and 15 are placed and the location of smart remote 16. Smart remote in this instance of the invention has a television selection application which allows the user to quickly select which television (14 or 15) smart remote 16 will control. The connection can be via Wi-Fi, or the like, so that the smart remote can control any television that has network access.

Second scenario, as smart remote 16 moves away from one television the paired secure communications link (20 or 21) stops and as the user approaches the physical location of the other television, the paired communications link for that television connects and communications are established. In this scenario, the user does not need to manually select which television (14 or 15) to communicate with.

Other embodiments are possible.

The present application has described use with only a few different kinds of formats, such as Bluetooth, but it should be understood that other formats can be used. The disclosed device and techniques could be used with any control device and any controlling device.

The system describes connecting with a network device, wirelessly Wi-Fi access point, however it should be understood that this can also use WPS to make the connection, and then transfer the credentials from the connection to the television.

The above has described special program as running in both the television and the tablet. However, a program such as an app can run in the tablet, and carry out all operations which are necessary to connect to the access point, and then use one or more techniques to communicate with the existing user interface in the television, that is without running a special program and the television. For example, this can send remote control commands to the television via Bluetooth, Wi-Fi, or via infrared commands. Once the tablet has been connected with the access point, the tablet can run a simulation program that simulates the actions that the user might carry out on an infrared remote, thus sending all the necessary infrared codes to the television, without the user needing to enter those codes.

The number of televisions that can be controlled with the smart remote is larger than two which is used in FIG. 3. For example, Bluetooth can address at least seven different devices and can setup “pico” nets with seven different devices on each pico-net.

Any consumer device with Wifi capability may benefit from the disclosed invention. These can include microwave ovens, normal kitchen ovens, refrigerators, household air conditioning and heating systems, home theater sound systems, security devices such as lights and opening sensors, swimming pool heaters and pumps, etc.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be controlled by a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
from a first device, connecting with an access point device providing a wireless Internet connection that requires entry of information about the access point device in order to connect to the wireless Internet connection;
entering said information on a user interface of said first device, where the user interface of the first device includes one of a keyboard or a touchscreen;
storing, in the first device, connection variables about a connection made with the access point device, where said connection variables include information that allows connecting to the wireless Internet connection;
connecting, from the first device, to a second device which has a limited user interface, and sending the information stored about the access point including the connection variables, to the second device and connecting from the second device to the access point device, using the connection variables.

2. The method as in claim 1, wherein the second device has a user interface that requires entering information by narrowing up an arrow and down without entering the information on a touchscreen or keyboard.

3. The method as in claim 1, further comprising viewing on the second device that the connection has been made without requiring selecting the connection variables.

4. The method as in claim 1, wherein said connection variables include a password which is entered on the first device.

5. The method as in claim 1, wherein a password is received wirelessly on the first device from an automatic connection sequence.

6. The method as in claim 1, further comprising sending the same information to a third device that has a limited user interface.

7. The method as in claim 6, further comprising connecting to both the second device and the third device, and selecting whether the second or third device is connected at any one time.

8. The method as in claim 1, wherein the connection variables include SSID and password of a wireless network.

9. The method as in claim 1, wherein the second device is a television.

10. The method as in claim 1, wherein the second device is one of a microwave ovens, a kitchen ovens, a refrigerator, household air conditioning and heating systems, home theater sound systems, security devices such as lights and opening sensors, swimming pool heaters and pumps.

11. A method, comprising:
operating a television, by powering on the television;
pairing with an intelligent remote control device from the television;
connecting to an access point device which provides Internet connection by using information received from the intelligent remote control, and without entering an SS ID or password of the access point device into the television.

12. An apparatus for controlling a remote device, comprising:
a remote control device, which operates to send remote commands to the remote device, which operate to control the remote device including controlling at least one function of the remote device, said remote control device having a user interface with one of a touchscreen or keyboard,
said remote control device having a function to connect with an access point device providing a wireless Internet connection, where connecting with the access point device requires entry of information about the access point device in order to connect to the wireless Internet connection;
said function to connect requiring a user entering said information on the user interface of said remote control device;
responsive to connecting with the access point device, said remote control device storing connection variables about a connection made with the access point device, where said connection variables include information that allows connecting to the wireless Internet connection;
responsive to a command from a user, sending information from the remote control device to the remote device, where the information stored about the access point including the connection variables.

13. The apparatus as in claim 12, wherein the remote device has a user interface that requires entering information by pressing the up, down, left, and right navigation arrows without entering the information on a touchscreen or keyboard.

14. The apparatus as in claim 12, wherein the remote device makes the connection with the access point device without entering data into the remote device and without selecting the connection variables on the remote device.

15. The apparatus as in claim 12, wherein said remote control device accepts entry of a password to be entered thereon, and stores said password, and send said password to said remote device.

16. The apparatus as in claim 12, wherein said remote control device receives a password automatically from an automatic connection sequence .

17. The apparatus as in claim 12, wherein said remote control device also sends information to a third device that has a limited user interface.

18. The apparatus as in claim 17, wherein said remote control device connects to both the remote device and the third device, and selecting whether the second or third device is connected at any one time.

19. The apparatus as in claim 12, wherein the connection variables include SSID and password of a wireless network.

20. The apparatus as in claim 12, wherein the remote device is a television.

21. The apparatus as in claim 12, wherein the remote device is one of a microwave ovens, a kitchen ovens, a refrigerator, household air conditioning and heating systems, home theater sound systems, security devices such as lights and opening sensors, swimming pool heaters and pumps.
